(19) United States
(12) Patent Application Publication
(10) Pub. No.: US 2013/0103633 A1
(43) Pub. Date: Apr. 25, 2013

(54) SYSTEM AND METHOD FOR DATING GELATIN SILVER PAPER

(71) Applicant: Paul Messier, Brighton, MA (US)

(72) Inventor: Paul Messier, Brighton, MA (US)

(21) Appl. No.: 13/276,440

(22) Filed: Oct. 19, 2011

(51) Int. Cl. G06N 5/02

(52) U.S. Cl. 706/52

(57) ABSTRACT

A system and method for dating gelatin silver photographic paper is provided. The system and method includes providing a database management system having temporal physical characteristic profiles. Each temporal physical characteristic profile consists of a pulp composition percentage characteristic; a fiber composition characteristic; a thickness characteristic; and an optical brightening agent composition. The system implements a program of instructions to determine a, probable date range for each temporal physical characteristic profile and also determines a physical characteristic profile associated with the gelatin silver photograph. Dating the photograph is accomplished by the system determining the closest match between the temporal physical characteristic profile and the physical characteristic profile associated with the gelatin silver photograph.

### BACKGROUND

1. Field of Use

These teachings relate generally to forensic photograph dating and more particularly to systems employing digital computers for determining the probabilistic date of a physical characteristic associated with a photograph.

2. Description of Prior Art (Background)

A photographic print's date is elementary to the understanding of the work, its historical context and the photographer's artistic intent. It carries implications for its treatment, display and storage and can manifestly influence its market value. Recently, photographs have become the target of forgers, and as the market value of these works increase, so will forgery continue. The detection of forged photography is particularly difficult, as experts must be able to tell the difference between originals and reprints. In addition, a forger's possession of the photo-negatives would allow a forger to print an unlimited number of fake prints, which then can be passed off as original. Since the composition of photographic paper was frequently changed, fake photographs are not likely to be printed on modern photographic paper or photographic paper not contemporaneous with the original photograph. Therefore, there is a need for a system to non-destructively date photographs.

### BRIEF SUMMARY

The foregoing and other problems are overcome, and other advantages are realized, in accordance with the presently preferred embodiments of these teachings. When a gelatin silver print, typically comprised of a paper support layer, a baryta layer, an image layer and often a coating layer, is subject to investigation, tangible information, such as the presence of optical brightening agents (1), manufacturer back printing (2), paper fiber analysis (3), and surface texture characterization (4), can corroborate dates range. Thus, in accordance with one embodiment of the present invention, a processor-based method for dating a gelatin silver print having a paper base layer, an optional baryta layer, a gelatin binder layer, and an optional protective gelatin layer is provided. The processor-based method includes providing a temporal classification dataset having temporal physical characteristics associated with a predetermined date. The processor-based method also includes determining at least one physical characteristic associated with the gelatin silver print and determining a manufacturing date associated with the gelatin silver print by determining the closest probability match between the temporal physical characteristics and the at least one physical characteristic associated with the gelatin silver print.

In accordance with another embodiment the invention includes a system for dating a gelatin silver print having a paper base layer, a baryta layer (often but not always required), a gelatin binder layer, and a protective gelatin layer. The system includes at least one temporal pulp composition characteristic associated with a predetermined date dataset. The system also includes a program storage device for containing a program of instructions executable by the machine to determine at least one physical characteristic associated with the gelatin silver print and determining the closest probability match between the at least one temporal pulp composition characteristic associated with the predetermined date and the at least one physical characteristic associated with the gelatin silver print.

The invention is also directed towards a method for dating gelatin silver photographs. The method includes providing a temporal physical characteristic dataset having temporal physical characteristic profiles. Each temporal physical characteristic profile consists of a pulp composition percentage characteristic; a fiber composition characteristic; a thickness characteristic; and an optical brightening agent composition, The optical brightening agent composition includes an optical brightening agent composition associated with the photographic paper layer and a second optical brightening agent associated with the photographic paper emulsion layer. Also included in the characteristic profile is a Barium/Strontium ratio characteristic. The method includes determining a probable date range for each temporal physical characteristic profile and determining a physical characteristic profile associated with the gelatin silver photograph. Dating the photograph is accomplished by determining the closest match between the temporal physical characteristic profile and the physical characteristic profile associated with the gelatin silver photograph.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram of a system configuration of an embodiment of the present invention;

FIG. 2A and FIG. 2B are block diagrams of an example classification regression tree for dating gelatin silver photographs in accordance with the invention shown in FIG. 1;

FIG. 3 is a pictorial example of a rag pulp method dataset in accordance with the invention shown in FIG. 1;

FIG. 4 is a pictorial example of clustering the rag pulp method dataset shown in FIG. 3;

FIG. 5 is a pictorial example of multiple pulp method datasets in accordance with the invention shown in FIG. 1; and

FIG. 6A and FIG. 6B are method flow charts for determining the data range of a gelatin silver photograph in accordance with the invention shown in FIG. 1.

### DETAILED DESCRIPTION

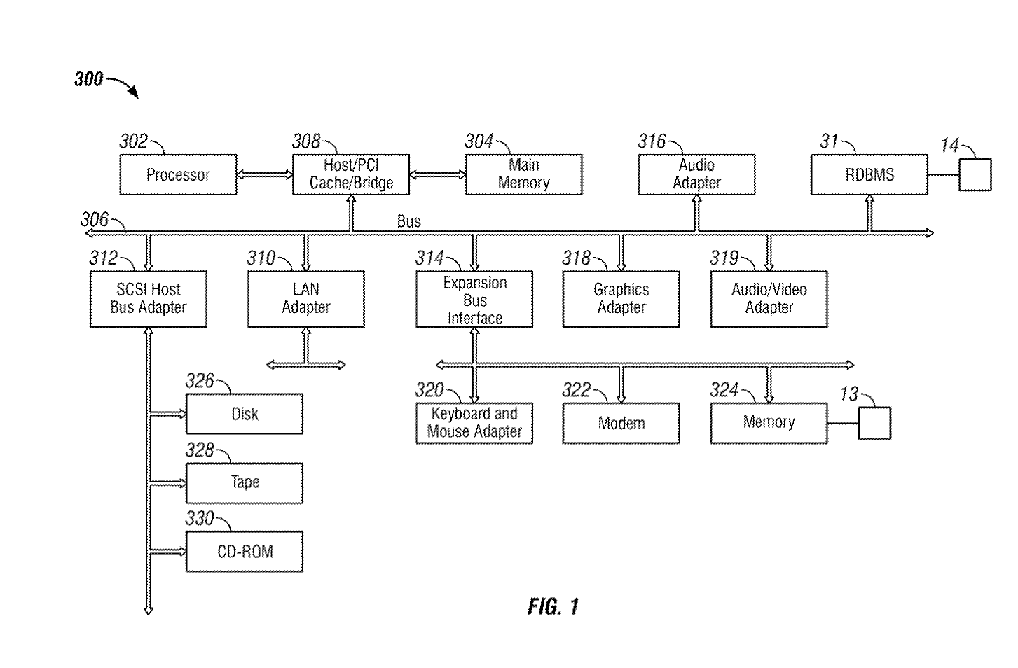

With reference now to FIG. 1, a block diagram illustrating a system 300 for dating gelatin silver photographs is depicted in which the present invention may be implemented. System 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, SCSI host bus adapter 312, and expansion bus interface 314 are connected to PCI local bus 306 by direct component connection. It will be understood that LAN adapter 310 may also include an internet browser. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support PCI expansion slots or add-in connectors.

An operating system runs on processor 302 and is used to coordinate and provide control of various components within data processing system 31. Data processing system 31 may be configured to process dataset 14 as described herein. The operating system may be any suitable commercially available operating system. In addition, an object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

System 300 may be configured to regressively cluster dataset 14 to allocate data points within the dataset to a probable date range. In some embodiments, such an adaptation may be incorporated within system 300. In particular, system 300 may include storage medium 324 with program instructions 13 executable by processor 16 to regressively cluster dataset 14. In an embodiment in which dataset 14 is external to system 10, however, the adaptation to regressively cluster dataset 14 may be additionally, or alternatively, incorporated within the respective data source/s of dataset 14. In particular, the data source/s of dataset 14, in such an embodiment, may include a storage medium with program instructions which are executable through a processor for regressively clustering data.

In general, input may be transmitted to system 300 to execute program instructions 13 within storage medium 324. Storage medium 324 may include any device for storing program instructions, such as a read-only memory, a random access memory, a magnetic or optical disk, or a magnetic tape. Program instructions 13 may include any instructions by which to perform the method or regression clustering and classification processes described below. In particular, program instructions 13 may include instructions for correlating variable parameters of a dataset and other instructions for clustering the dataset through the iteration of a regression algorithm. In this manner, program instructions 13 may used to generate a plurality of different functions correlating variable parameters of a dataset. In addition, program instructions 13 may include instructions for determining directives by which to classify new data into the dataset with respect to the generated functions. In some cases, program instructions 13 may further include instructions by which to receive new data and predict values of variable parameters associated with the new data and dataset.

Those of ordinary skill in the art will appreciate that the hardware in FIG. 1 may vary depending on the implementation. Other internal hardware or peripheral devices, such as flash read-only memory (ROM), equivalent nonvolatile memory, or optical disk drives and the like, may be used in addition to or in place of the hardware depicted in FIG. 1.

The depicted example in FIG. 1 and above-described examples are not meant to imply architectural limitations. For example, system 300 also may be a notebook computer or hand held computer in addition to taking the form of a PDA.

Before describing the new system in accordance with the invention, it would be helpful to describe the classification/regression tree methodology and an illustrative classification/regression tree. The general classification/regression tree methodology is described in detail in L. Breiman, Classification and Regression Trees, (Wadsworth & Brooks/Cole Advanced Books & Software, Pacific Grove, Calif.: 1984). The methodology provides an arrangement for classifying individual records in, for example, a database, to a selected class based on data contained in the respective records. For each record, the methodology makes use of a set of inquiries applied to data contained in each record. First an initial inquiry is applied, and the response to that inquiry provides a basis for selecting a subsequent inquiry. This process is repeated through a series of inquiries until a response to a particular inquiry identifies a class to which the record is to be assigned. Generally, the series of inquiries applied to a particular record is a subset of the entire set of inquiries that may be applied. If each inquiry is analogized to a node, the set of nodes and their order of application resemble a tree. Such a tree can be used to perform classification and/or regression analysis, and will be generally identified herein as a “classification/regression tree.”

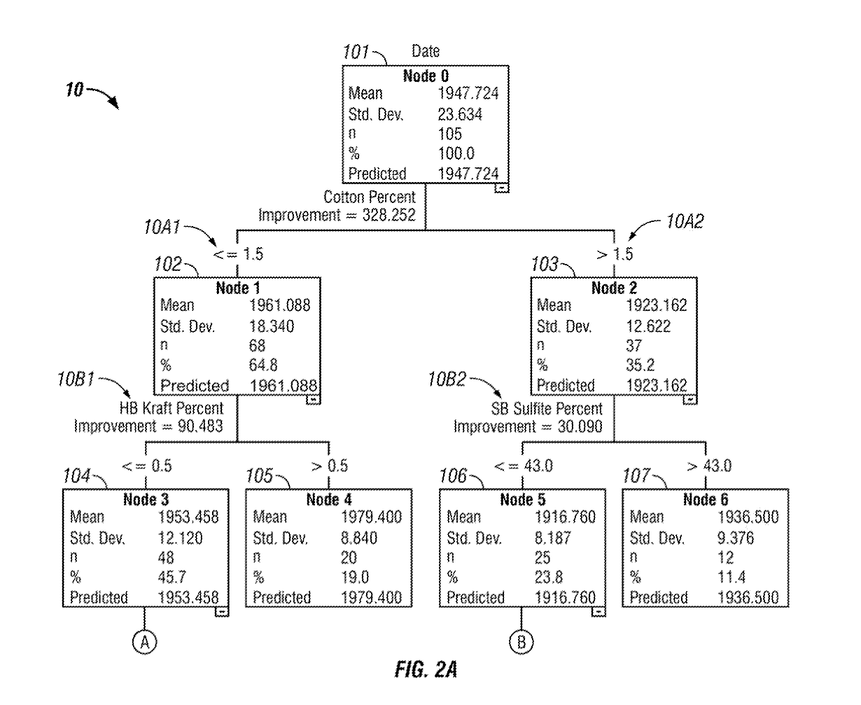

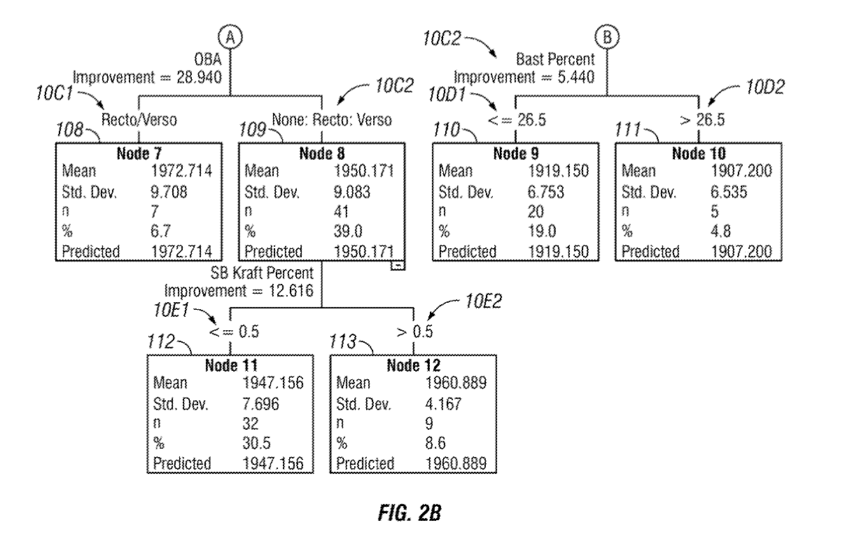

More specifically, and with reference to FIG. 2A and FIG. 2B, a pulp method classification/regression tree 10 is a binary tree that includes a number of nodes extending from a root node 101 to a number of leaf nodes 102-113. The tree 10 is used to classify a record into one of a selected number of classes. A record includes a number of fields, one of which is identified as a “dependent” field or dependent variable, with the remaining fields being identified as “independent” fields or independent variables. The diverse values which the data contained in the dependent field can take on identify the “classes” into which the records can be classified, and the classification of each record is based on the values contained in the independent fields; otherwise stated, the tree 10 determines a value for the dependent field (the record's class), which is otherwise unknown, based on the contents of some or all of the independent fields.

Each node 101-113 in the tree 10 represents a query to be applied to one of the independent fields, with the response to the query comprising a “yes” or a “no.” An illustrative query may have the form “Is the value of “cotton percentage” (equal to or less than,) a selected value 10A1?”, where field “cotton percentage” is a field containing one of the independent variables and the selected value is a value determined by the tree generating system while generating the tree. If the answer to the query at a particular node is a “yes,” the query at its left child node is applied, but if the answer is a “no,” the query at the node's right child node is applied, and so the “selected value” used in each query, which is determined for the corresponding node during tree generation will be referred to herein as a “splits” value.

The queries of the tree are applied beginning with the root node 101; if the response of the root node's query is “yes,” the left child node's question is then applied to the record; on the other hand, if the answer to the root node's query is “no,” the right child node's query is then applied to the record. This process is repeated for the record at each node from the root node along a path through a series of intermediate nodes to the last, or terminal, node, and the response at the leaf node identifies the class into which the record should be classified; that is, the response at the terminal node provides an indication as to the value of the dependent field. The particular class identified by the classification/regression tree 10 for a particular record has an associated probability or confidence value indicating the likelihood that the record is, in fact, properly classified in the class identified by the tree 10.

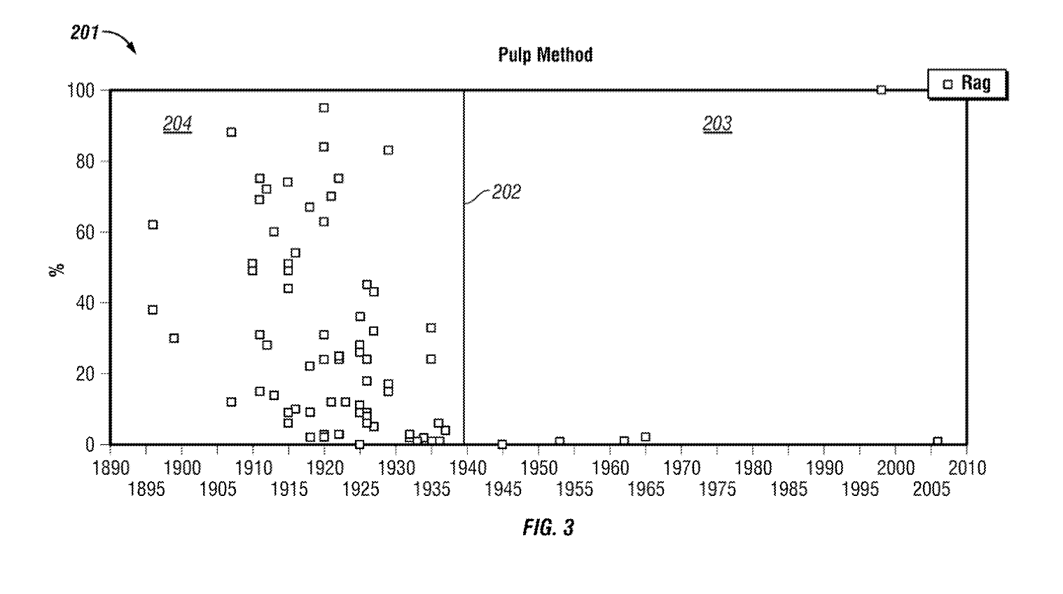

For example, still referring to FIG. 2A and FIG. 2B, and for example purposes only, Node-0 102, and also FIG. 3, it will be appreciated that the majority of rag pulp (derived from cotton or flax) data points in temporal rag pulp dataset 201 for years less than 1940 (i.e., those data points to the left of line 202) can be calculated to be above 1.5%. It will be appreciated that data points within a database may be statistically grouped by any suitable means. For example, data points in section 204, i.e., those data points calculated to be above 1.5% may be statistically grouped as a standard or normal distribution group with a mean and standard deviation as shown in Node 1 102.

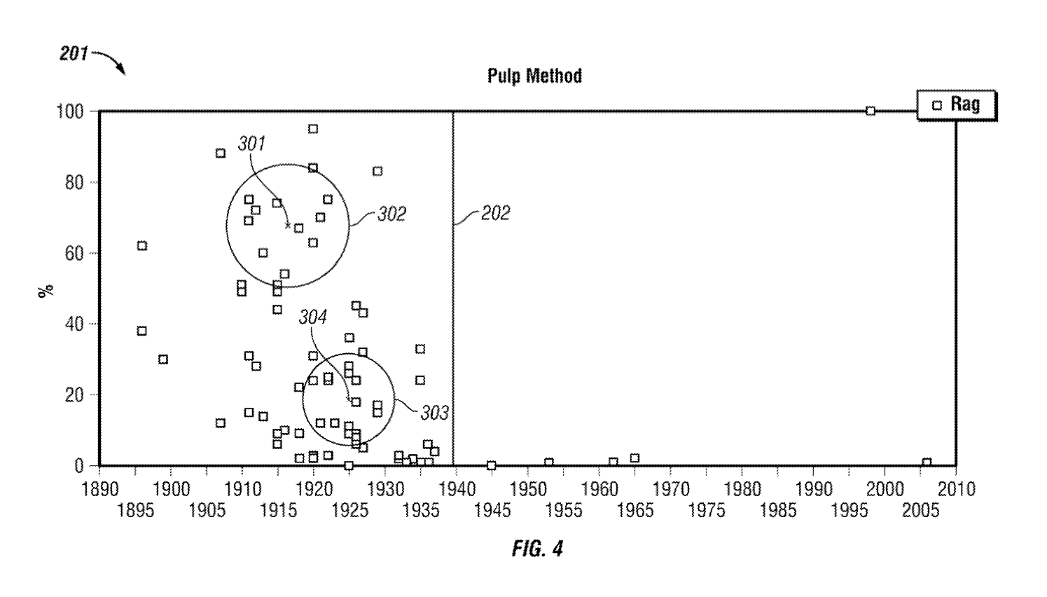

Referring also to FIG. 4, it will be appreciated that rag or cotton pulp data points may be clustered as shown by cluster circles 302 and 303. Center points, or comparison means, for classifying new data points within the dataset, may be calculated by suitable processes, such as, for example, K-means clustering

As is known in the art it will be appreciated that the partition of the dataset 14 can be “hard” or “soft.” A “hard” partition may refer to the designation of every of data point within dataset 14 belonging to a specific subset of data points. In this manner, the partitions of the data points may be clear and distinct. A “soft” partition, however, may refer to the ambiguous groupings of data points within subsets of dataset 14. In some cases, such a categorization of data points may depend on the probability of data points belonging to particular subsets within dataset 14 rather than other subsets.

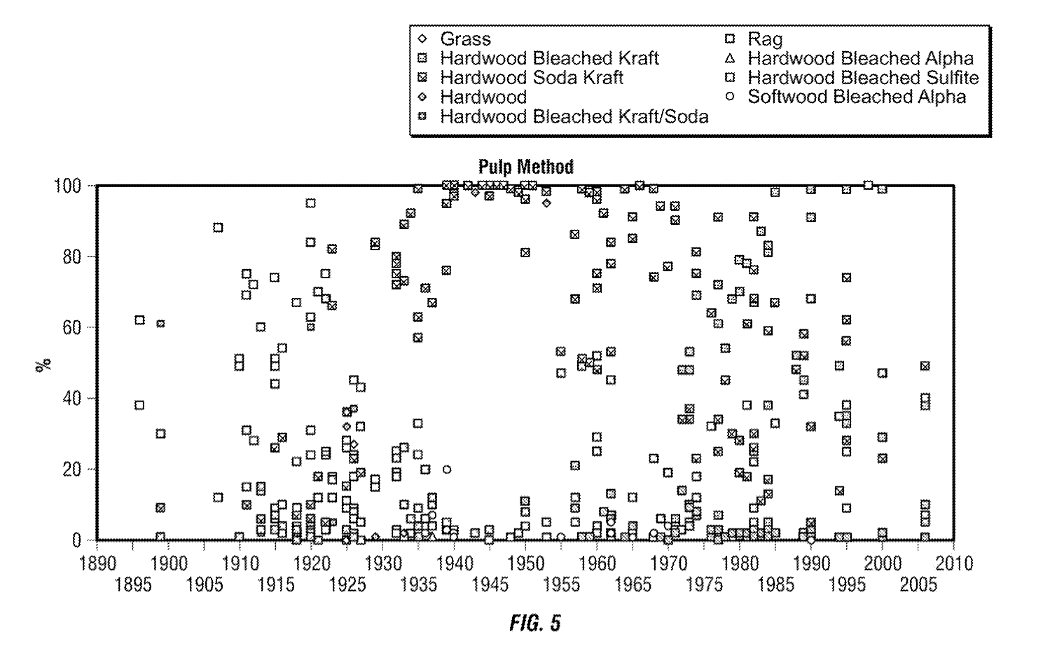

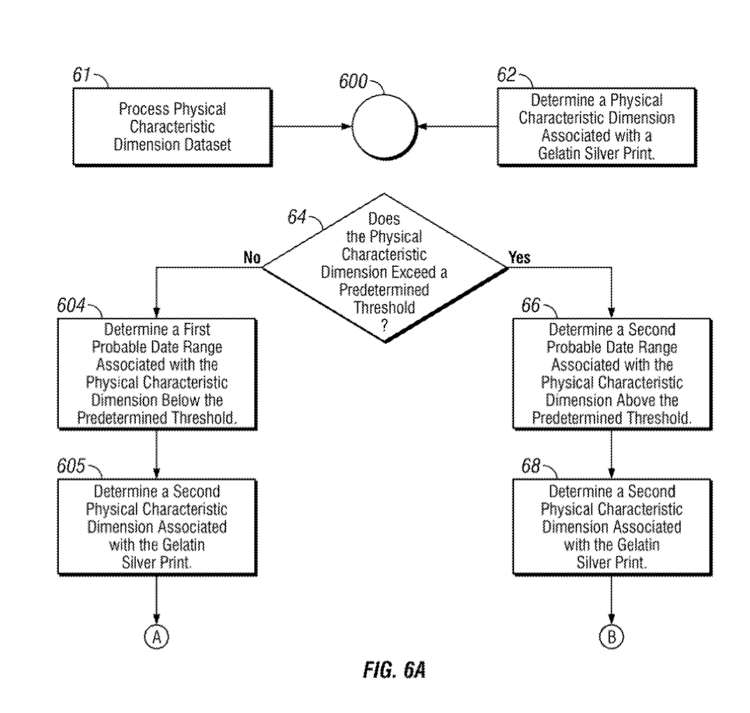

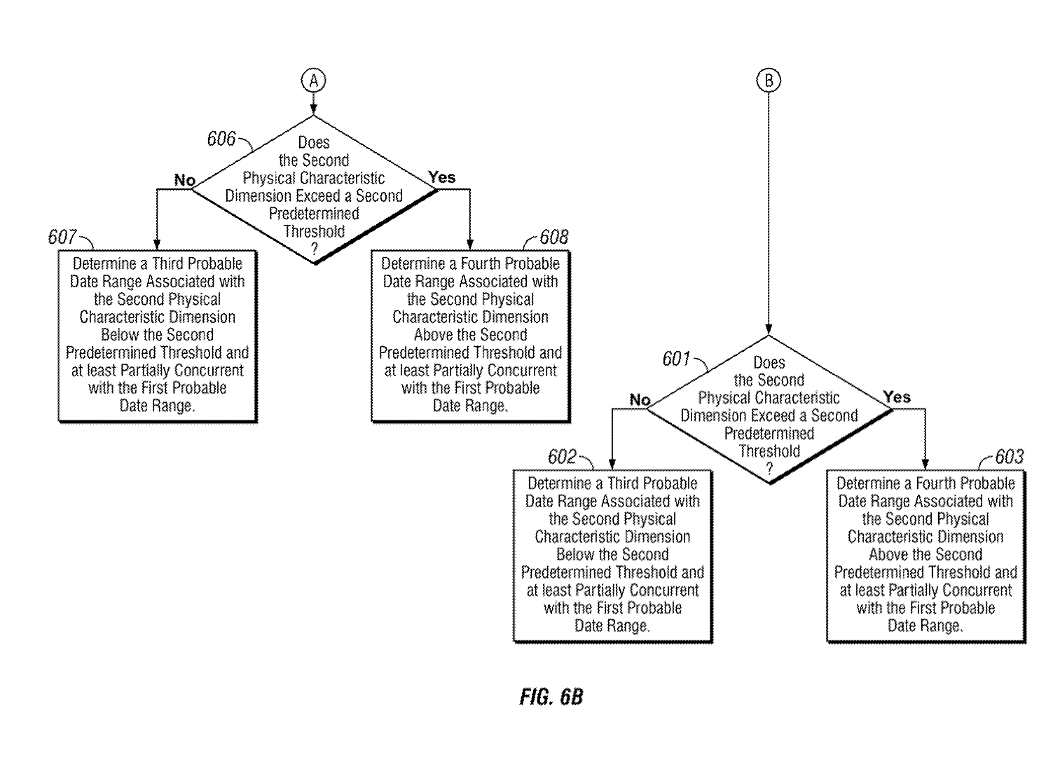

Referring now to FIG. 6A and FIG. 6B, there are shown flowcharts illustrating one method for determining a probable date range for a gelatin silver photograph. Process 61 processes a physical characteristic dimension dataset, such as, for example, the dataset shown in FIG. 5. The dataset may be processed by any suitable means such that the dataset represents a likely date range for each physical characteristic in the dataset, or a group of physical characteristics in the dataset. For example, a physical characteristic profile 501 shown in FIG. 5 may be used to compare with a physical characteristic profile determined for a photograph of interest.

Still referring to FIG. 6A and FIG. 6B, process 62 determines a physical characteristic dimension associated with the gelatin silver photograph. The physical characteristic may be any suitable physical pulp characteristic such as, for example, grass, hardwood bleached kraft, hardwood soda/kraft, hardwood, hardwood bleached kraft/soda, rag or cotton, hardwood bleached alpha, hardwood bleached sulfite, softwood bleached alpha. In addition, the physical characteristic may also be any suitable chemical composition or ratio, such as, for example, Barium/Strontium ratio or an X-ray fluorescence characteristic. The dimension associated with the physical characteristic may be any suitable dimension such as, for example, weight, or thickness.

It will also be appreciated that the dimension may be stated in terms of a percentage or ratio of the physical characteristic to other physical characteristics associated with the gelatin silver photograph. It will also be understood that a physical dimension may also include location of a physical characteristic, such as, for example, the presence or absence of an optical brightening agent on the front or back of the photograph. Combiner 600 combines information from process 62 and dataset 61. Decision point 64 determines if the physical characteristic dimension exceeds a predetermined threshold. For example, see FIG. 2B, 10E2 where SBkraft (Softwood bleached kraft) exceeds 0.5%.

Continuing with FIG. 6, process 66 determines a probable date range associated with the physical characteristic dimension below a predetermined threshold. For example, referring to FIG. 2B, Node-12 113, and the probable, or mean, date range for SBkraft (Softwood bleached kraft) exceeding 0.5% is approximately 1960 with a standard deviation of approximately 4 years. Process 68 continues the analysis with determining a second physical characteristic associated with the gelatin silver print. Decision point 601 determines if the second physical characteristic exceeds the predetermined threshold for that characteristic. Process 603 determines another probable date range associated with the second physical characteristic dimension that is at least partially concurrent with the preceding date range. It will be understood that the predicted date for a particular physical characteristic has a higher probability of being within one standard deviation from the mean date. It will be further understood that the chained probabilities, i.e., for example, referring to FIG. 2A and FIG. 2B, Node-1 102, Node-3 104, Node 7 108 may be suitably combined to generate the most likely comprehensive date range for the physical characteristic dimensions within the chain.

It should be understood that the foregoing description is only illustrative of the invention. Thus, various alternatives and modifications can be devised by those skilled in the art without departing from the invention. Accordingly, the present invention is intended to embrace all such alternatives, modifications and variances that fall within the scope of the appended claims.

What is claimed is:

1. A processor-based method for dating a gelatin silver print having a paper base layer, a baryta layer, a gelatin binder layer, and a protective gelatin layer, the method comprising:
providing a temporal classification dataset, the temporal classification dataset comprising:
at least one temporal physical characteristic associated with a predetermined date;
determining the at least one physical characteristic associated with the gelatin silver print; and
calculating a printing date associated with the gelatin silver print, wherein calculating the printing date associated with the gelatin silver print comprises:
determining the closest probability match between the at least one temporal physical characteristic associated with the predetermined date and the at least one physical characteristic associated with the gelatin silver print.

2. The processor-based method as in claim 1, wherein the at least one temporal physical characteristic associated with the predetermined date comprises a temporal physical characteristic percentage.

3. The processor-based method as in claim 2, wherein the at least one temporal physical characteristic comprises a pulp composition associated with the predetermined date.

4. The processor-based method as in claim 2, wherein the at least one temporal physical characteristic comprises a fiber composition associated with the predetermined date.

5. The processor-based method as in claim 1, wherein the at least one temporal physical characteristic associated with the predetermined date comprises at least one thickness characteristic associated with the predetermined date.

6. The processor-based method as in claim 1, wherein the at least one temporal physical characteristic associated with the predetermined date comprises at least one optical brightening agent composition associated with the predetermined date.

7. The processor-based method as in claim 6, wherein the at least one optical brightening agent composition associated with the predetermined date comprises at least one optical brightening agent associated with the paper layer.

8. The processor-based method as in claim 6, wherein the at least one optical brightening agent composition associated with the predetermined date comprises at least one second optical brightening agent associated with the emulsion layer.

9. The processor-based method as in claim 1, wherein the at least one temporal physical characteristic associated with the predetermined date comprises at least one X-ray fluorescence characteristic.

10. The processor-based method as in claim 1, wherein the at least one temporal physical characteristic associated with the predetermined date comprises at least one Barium/Strontium ratio.

11. The processor-based method as in claim 9, wherein the at least one at least one Barium/Strontium ratio associated with the predetermined date comprises at least one second X-ray fluorescence characteristic associated with the Barium/Strontium ratio.
determining at least one fiber species associated with the gelatin silver print; and
determining the closest probability match between the plurality of temporal pulp process percentage dates and the at least one pulp process percentage associated with the gelatin silver print. at least one temporal fiber species percentage date;
determining at least one physical characteristic associated with the gelatin silver print; and
determining at least one pulp process percentage associated with the gelatin silver print.

12. A system, adaptable to internet communications, for dating a gelatin silver print having a paper base layer, a baryta layer, a gelatin binder layer, and a protective gelatin layer, the system comprising:
at least one dataset, the at least one dataset comprising:
at least one temporal physical characteristic associated with a predetermined date, wherein the at least one physical characteristic comprises a pulp composition associated with the predetermined date;
a program storage device readable by the system, wherein the program storage device tangibly embodies a program of instructions executable by the system to:
determine the at least one physical characteristic associated with the gelatin silver print; and
calculate a printing date associated with the gelatin silver print, wherein calculating the printing date associated with the gelatin silver print comprises:
determining the closest probability match between the at least one temporal physical characteristic associated with the predetermined date and the at least one physical characteristic associated with the gelatin silver print.

13. The system as in claim 12, wherein the pulp composition comprises a pulp composition selected from the group consisting of grass, bleached hardwood Kraft, hardwood soda Kraft, hardwood, bleached hardwood Kraft soda, rag, bleached hardwood alpha, bleached hardwood sulfite, and bleached softwood alpha.

14. The system as in claim 13, wherein the at least one temporal physical characteristic associated with the predetermined date comprises a temporal physical characteristic profile, wherein the temporal characteristic profile comprises:
at least one pulp composition percentage;
a fiber composition;
at least one thickness characteristic;
an optical brightening agent composition wherein the optical brightening agent composition comprises:
at least one first optical brightening agent composition associated with the paper layer;
at least one second optical brightening agent associated with the emulsion layer; and
at least one Barium/Strontium ratio.

15. The system as in claim 14 further comprising at least one internet browser client, wherein the at least one internet browser client is adaptable to internet connecting the system, and wherein the at least one browser client comprises means for displaying the closest probability match between the at least one temporal physical characteristic associated with the predetermined date and the at least one physical characteristic associated with the gelatin silver print.

16. A method for dating a gelatin silver photographs, the method comprising:
providing a temporal physical characteristic dataset, wherein the temporal physical dataset comprises a plurality of temporal physical characteristic profiles, wherein each temporal physical characteristic profile comprises:
at least one pulp composition percentage characteristic;
a fiber composition characteristic;
at least one thickness characteristic;
an optical brightening agent composition, wherein the optical brightening agent composition comprises:
at least one first optical brightening agent composition associated with the paper layer;
at least one second optical brightening agent associated with the emulsion layer; and
at least one Barium/Strontium ratio characteristic.
processing the temporal physical characteristic dataset, wherein processing the temporal physical characteristic dataset comprises:
determining a probable date range for each temporal physical characteristic profile;
determining a physical characteristic profile associated with the gelatin silver photograph; and
determining the closest match between the temporal physical characteristic profile and the physical characteristic profile associated with the gelatin silver photograph.
